(19) United States
(12) Patent Application Publication
(10) Pub. No.: US 2022/0279726 A1
(43) Pub. Date: Sep. 8, 2022

(54) INLET COVER FOR A CROSS FLOW FAN

(71) Applicant: CNH Industrial America LLC, New Holland, PA (US)

(72) Inventor: Jonathan E. Ricketts, Davenport, IA (US)

(21) Appl. No.: 17/685,736

(22) Filed: Mar. 3, 2022

Related U.S. Application Data
(60) Provisional application No. 63/156,579, filed on Mar. 4, 2021.

(51) Int. Cl. A01F 12/44; F04D 17/00; F04D 29/28; F04D 29/42; A01F 12/48

(52) U.S. Cl. CPC A01F 12/444; F04D 17/00; F04D 29/281; F04D 29/4226; A01F 12/48

(57) ABSTRACT

A harvester cleaning fan system having a cross flow fan rotor, an inlet, an outlet and an inlet cover. The rotor rotates about a fan axis and has vanes defining a cylindrical rotation volume. The inlet extends around the rotor from an inlet leading edge to an inlet trailing edge. The outlet extends from the inlet trailing edge to the inlet leading edge. The inlet cover is adjacent the inlet, radially spaced from the rotor, and extends from a cover leading edge to a cover trailing edge. The cover leading and trailing edges are between the inlet leading and trailing edges. A first inlet passage is between the cover leading edge and the inlet leading edge, and a second inlet passage is between the inlet trailing edge and the cover trailing edge. An agricultural vehicle having a cleaning fan is also provided.

### FIELD OF THE INVENTION

This invention relates generally to a combine harvester cleaning systems, and, more particularly, to cleaning fan systems for use in harvester cleaning systems.

### BACKGROUND OF THE INVENTION

FIG. 1 depicts a representative combine harvester 100 constructed and operable generally as known in the art. The non-inventive aspects of combine harvesters 100 are of conventional, well-known construction and operation. The harvester 100 is representative of a wide variety of combine harvesters for grains such as, but not limited to, wheat and other grasses, corn, and legumes such as soybeans. U.S. Pat. No. 9,462,752, which is incorporated by reference herein in its entirety, describes other details of exemplary combine harvesters.

Generally, the harvester 100 is a self-propelled vehicle having a chassis 102 that is supported for movement on the ground by a plurality of wheels 104 (e.g., pneumatic tires, tracked wheels, etc.). At a forward end, the harvester 100 has a header 106 operable for severing plants from the ground as the harvester 100 is moved in the forward direction. The header 106 is configured and operable for gathering the cut crops and directing them into a feeder 108. The feeder 108 then conveys the cut crops to a threshing system 110 located generally within the harvester 100.

The harvester 100 also includes a cleaning system 120 for carrying crop material from the threshing system 110, and separating grain from material other than grain (“MOG”). The cleaning system 120 typically includes a cleaning fan system 130, a plurality of sieves 140A, 140B, and 140C, and a plurality of augers 150A, 150B, and 150C. The cleaning fan system 130 comprises a cleaning fan 132 for generating and directing a flow of air upwardly and rearwardly over the sieves 140A, 140B, and 140C (collectively “sieves 140”). The sieves 140 allow grain to fall through, while preventing MOG of various sizes from passing. The augers 150A, 150B, and 150C or other grain conveyors are located below the sieves 140 to collect grain. A grain pan 160 also may be provided to help direct grain from the threshing system 110 to the sieves 150.

The cleaning fan 132 typically is a cross-flow fan, which receives air from an inlet region 134, and directs it to one or more outlet ducts 136. A cutoff 138 divides the outlet ducts 136 from the inlet region 134. Air passing through the outlet ducts 136 is delivered to sieves 140 to blow MOG from the grain.

In this example, the cleaning system has three sieves 140A-140C in a sequential arrangement to perform successively finer separation of grain from MOG. Thus, the airflow from the cleaning fan 132 must be distributed to multiple locations by the system of outlet ducts 136. Each sieve 140 may require a different volume of air to operate in an ideal manner, and thus the outlet ducts 136 are designed to distribute the airflow, as best as possible, to each sieve 140. In some cases, the outlet ducts 136 also may include adjustable deflectors or dampers, to help modify the airflow distribution to address variations in grain properties or operating conditions.

As will be appreciated from the foregoing, the performance of the cleaning fan 132 itself has an effect on the operation of the rest of the cleaning system. An ongoing problem with existing cleaning fans 132 is evenly distributing the airflow across the width of the outlet ducts 136. Even distribution of airflow generally leads to more uniform cleaning across the width of the sieves 140, and greater cleaning efficiency. The problem of achieving uniform airflow distribution across the width is exacerbated by the nature of cross-flow fans, and efforts to make the cleaning system as wide as possible to accommodate greater volumes of incoming crop material.

This description of the background is provided to assist with an understanding of the following explanations of exemplary embodiments, and is not an admission that any or all of this background information is necessarily prior art.

### SUMMARY OF THE INVENTION

In a first exemplary aspect, there is provided a harvester cleaning fan system comprising: a cross flow fan rotor configured to rotate about a fan axis in a rotation direction and extending along the fan axis by a fan rotor length, the cross flow fan rotor having a plurality of vanes, each of the plurality of vanes extending in a radial direction away from the fan axis, from a respective proximal vane edge to a respective distal vane edge, the distal vane edges defining a cylindrical rotation volume having a rotation diameter; a fan inlet extending in the rotation direction around a first portion of the cylindrical rotation volume from a fan inlet leading edge to a fan inlet trailing edge; a fan outlet extending in the rotation direction from the fan inlet trailing edge to the fan inlet leading edge to enclose a second portion of the cylindrical rotation volume; and an inlet cover positioned adjacent to the fan inlet and spaced in the radial direction outwardly from the rotation volume, the inlet cover extending in the rotation direction from an inlet cover leading edge to an inlet cover trailing edge, and extending along the fan axis along at least a majority of the fan rotor length. The inlet cover leading edge and inlet cover trailing edge are located with respect to the rotation direction between the fan inlet leading edge and the fan inlet trailing edge. The inlet cover leading edge is spaced in the rotation direction from the fan inlet leading edge to form a first inlet passage, and the fan inlet trailing edge is spaced in the rotation direction from the inlet cover trailing edge to form a second inlet passage.

In some examples, the inlet cover extends along the fan axis along an entirety of the fan rotor length.

In some examples, the rotation diameter is about 400 mm to about 500 mm, and at least one of the inlet cover leading edge and the inlet cover trailing edge is spaced in the radial direction from the rotation volume by about 60 to about 90 mm.

In some examples, the inlet cover leading edge is spaced in the radial direction from the rotation volume by about 75 mm.

In some examples, the inlet cover comprises at least curved portion having a concave side facing the fan rotor.

In some examples, the inlet cover leading edge is spaced in the radial direction from the rotation diameter by a first distance, the inlet cover trailing edge is spaced in the radial direction from the rotation volume by a second distance, and the second distance is greater than the first distance.

In some examples, the rotation diameter is about 400 mm to about 500 mm; at least one of the inlet cover leading edge and the inlet cover trailing edge is spaced in the radial direction from the rotation volume by about 60 to about 90 mm; the curved portion has a radius of about 170 mm to about 210 mm; and the curved portion extends along the radial direction by at least about 180 mm.

In some examples, the inlet cover further comprises a baffle extending from the inlet cover trailing edge towards the fan rotor.

In some examples, the curved portion extends from the inlet cover leading edge to an intermediate location between the inlet cover leading edge and the inlet cover trailing edge.

In some examples, the inlet cover comprises a planar portion extending from the intermediate location to the inlet cover trailing edge.

In some examples, the rotation diameter is about 400 mm to about 500 mm; at least one of the inlet cover leading edge and the inlet cover trailing edge is spaced in the radial direction from the rotation volume by about 60 to about 90 mm; the curved portion has a radius of about 170 mm to about 210 mm; the curved portion extends along the radial direction by at least about 180 mm; and the planar portion extends at least about 100 mm from the intermediate location to the inlet cover trailing edge.

In some examples, the inlet cover further comprises a baffle extending from the inlet cover trailing edge towards the fan rotor.

In some examples, the inlet cover comprises a solid surface.

In some examples, the inlet cover comprises a plurality of openings.

In some examples, the inlet cover comprises a perforated sheet having an open area of about 30% to about 50%.

In some examples, the inlet cover comprises an expanded metal sheet.

In another exemplary aspect, there is provided an agricultural vehicle having a chassis configured for movement along a surface, one or more sieves configured to separate grain from material other than grain, and a fan system as described in the foregoing aspects and examples.

### BRIEF DESCRIPTION OF THE DRAWINGS

Embodiments of inventions will now be described, strictly by way of example, with reference to the accompanying drawings, in which:

FIG. 1 illustrates a prior art agricultural harvester.

FIG. 2 illustrates a first example of a grain cleaning fan system shown in cross-section view.

FIG. 3A illustrates the grain cleaning fan system of FIG. 2 in perspective.

FIG. 3B illustrates an alternative example of an inlet cover.

FIG. 3C illustrates an alternative example of an inlet cover.

In the figures, like reference numerals refer to the same or similar elements.

### DETAILED DESCRIPTION OF THE DRAWINGS

The drawing figures depict one or more implementations in accordance with the present concepts, by way of example only, not by way of limitations. The examples are shown in conjunction with an agricultural combine harvester, but have applicability in any similar agricultural vehicle.

The terms “crop material,” “grain,” and “MOG” are used in this specification principally for convenience, but it will be understood that these terms are not intended to be limiting. “Crop material” refers to the material removed from the ground and delivered to the cleaning system via the threshing system 110. “Grain” is that part of the crop material that is threshed and separated from the remainder of the crop material and kept for further processing, and the portion of the crop material that is left behind during the harvesting process is referred to as the material other than grain (“MOG”).

The terms “forward,” “rearward,” “left,” and “right,” and the like, when used in connection with movable agricultural equipment such as an agricultural harvester and/or components thereof, are usually determined with reference to the normal direction of forward operative travel of the harvester; but, again, they should not be construed as limiting. The terms “longitudinal” and “transverse” are determined with reference to the fore-and-aft direction of the agricultural harvester and are equally not to be construed as limiting.

It has been found that it can be difficult to predictably develop a high-efficiency cleaning fan system for use in agricultural combine harvesters. Cross flow fans are typically used for this purpose, and such fans typically provide a somewhat uniform airflow distribution across the length of the fan (i.e., along the direction of the rotation axis). However, variations in airflow do exist, and, in the context of a combine harvester, such airflow variations can be detrimental to uniform and complete separation of grain from MOG. This problem is exacerbated by the facts that combine harvesters operate in varying environmental conditions, and the crop material can vary significantly in shape, size, texture, moisture content, density, and so on. In addition, the increasing width of modern harvesters creates greater disparity in the airflow pattern. Still further, cross flow fans can exhibit airflow variations in the direction perpendicular to the plane of the rotating axis, which leads to uneven or unpredictable airflow distribution between the passages of a divided outlet duct (e.g., an outlet duct that separates into multiple passages to feed different sieves). Still other problems are caused by fluctuations (variations over time) in the airflow, which can be caused by changes in atmospheric conditions, changes in backpressure at the outlet caused by crop material loading, and so on. Such factors, and others, make it very difficult to identify ideal cross flow fan parameters for use in combine harvesters.

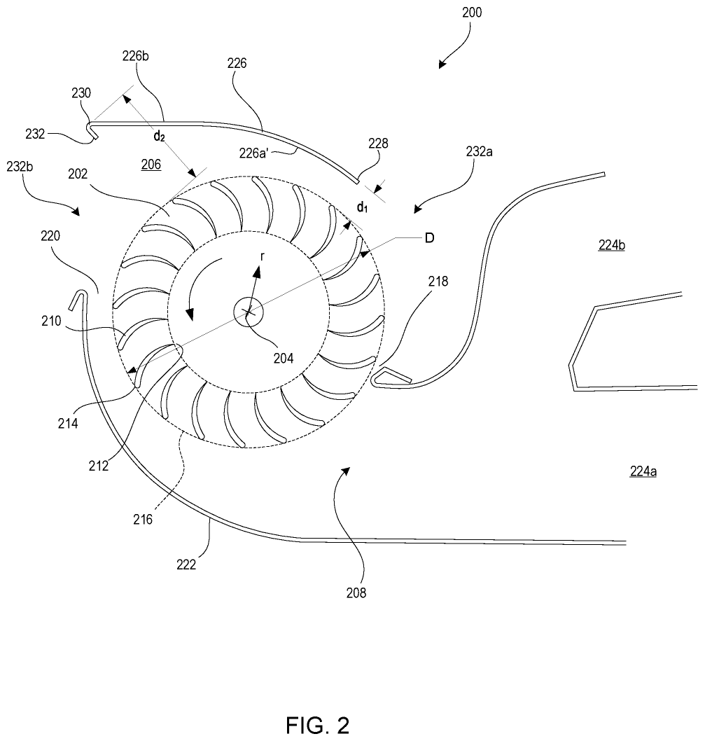

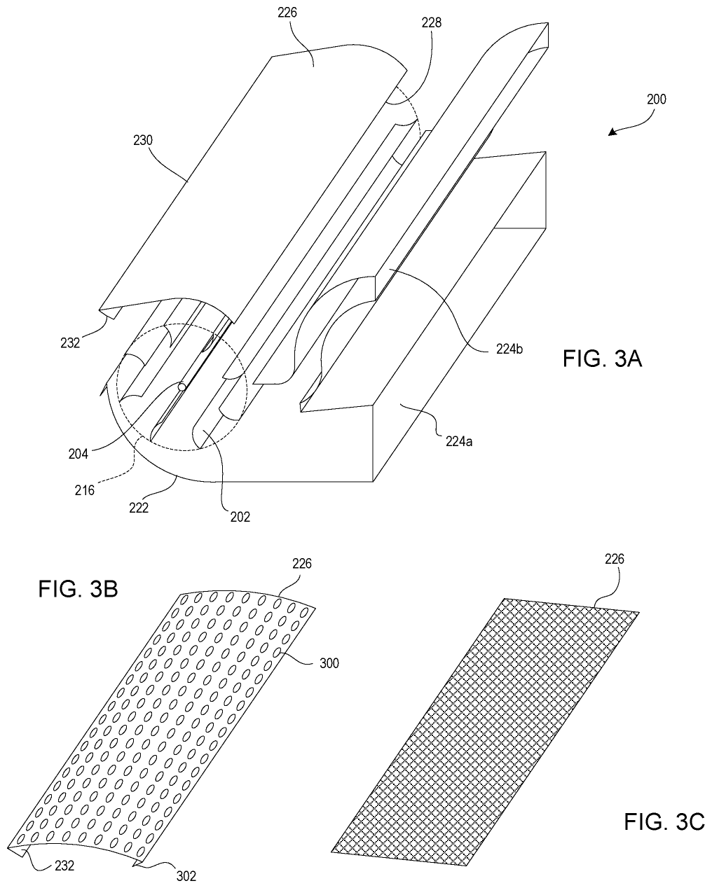

Despite the foregoing difficulties, the inventors have determined that combine cleaning systems and obtain significant benefits in cleaning fan operation by using a cross flow fan having certain structural and dimensional features. Examples of such improved cleaning fan systems are shown in FIGS. 2-3C.

Referring to FIG. 2, a first embodiment of an improved cleaning fan system 200 is illustrated in cross section. The cleaning fan system 200 includes a cross flow fan rotor 202 that is configured to rotate about a fan axis 204 in a rotation direction (curved arrow), a fan inlet 206, and a fan outlet 208.

The fan rotor 202 extends along the fan axis 204 to define a fan rotor length. The fan rotor 202 has a plurality of vanes 210, each of which extends in a radial direction r away from the fan axis 204. Each vane 210 extends in the radial direction r from a respective proximal vane edge 212 to a respective distal vane edge 214. The distance between the proximal vane edge 212 and distal vane edge 214 along the radial direction r is defined herein as the radial vane distance R. The distal vane edges 214 define a cylindrical rotation volume 216 and a fan rotation diameter D at their outermost path of travel in the radial direction r.

The fan inlet 206 extends in the rotation direction, preferably along the full length of the fan rotor 202. The fan inlet 206 extends, relative to the rotation direction r, around a first portion of the cylindrical rotation volume 216, from a fan inlet leading edge 218 to a fan inlet trailing edge 220. The fan inlet 206 comprises an open area through which air can flow into the fan rotor 202. One or more air cleaning systems (e.g., screens, filters, etc.) may be placed upstream of the fan inlet 206, as known in the art.

The fan outlet 208 is located opposite the fan inlet 206, and extends generally from the fan inlet trailing edge 220 to the fan inlet leading edge 218. The fan outlet 208 is defined by a volute-shape enclosure 222 that encloses second portion of the cylindrical rotation volume 216. The enclosure 222 extends along the length of the fan rotor 202, and is closed at each end to form a chamber to receive air from the fan rotor 202. The enclosure 222 extends downstream to one or more outlet ducts 224a, 224b, as known in the art.

The fan cleaning system 200 also includes an inlet cover 226. The inlet cover 226 is located adjacent to the fan inlet 206, and spaced in the radial direction r away from the rotation volume 216. The inlet cover 226 extends in the rotation direction from an inlet cover leading edge 228 to an inlet cover trailing edge 230. The inlet cover 226 extends along the rotation axis 204, and preferably extends along the entire length of the fan rotor 202. However, it is expected that beneficial results can be obtained if the inlet cover 226 extends along at least half (i.e., a majority) of the fan rotor length. The inlet cover 226 also may be formed by multiple discrete segments that have between them along the direction of the rotation axis 204.

The inlet cover leading edge 228 and inlet cover trailing edge 230 are located, with respect to the rotation direction, between the fan inlet leading edge 218 and the fan inlet trailing edge 220. Furthermore, as shown in FIG. 2, the inlet cover leading edge 228 is spaced in the rotation direction from the fan inlet leading edge 218 to form a first inlet passage 232a, and the fan inlet trailing edge 230 is spaced in the rotation direction from the inlet cover trailing edge 220 to form a second inlet passage 232b.

In use, the inlet cover 226 impedes air from flowing into the air inlet 206, and is expected to decrease the overall volumetric flow rate of air. This reduction in flow rate would normally be considered detrimental to providing efficient and effective grain separation. However, it has been unexpectedly discovered that, despite this impediment, the grain separation performance is improved. Without being bound to any theory of operation, it is believed that the inlet cover 226 causes the air to enter the first inlet passage 232a and second inlet passage 232b in respective bands. This redirection of the air is believed to help redistribute the incoming air along the length of the fan rotor 202, reducing the natural inclination for more air to pass through the longitudinal center region of the fan rotor 202. The resulting airflow pattern provides more a consistent volumetric air flow rate across the fan rotor length, leading to more uniform distribution of the air downstream of the fan rotor 202, and thus more uniform grain separation at the sieves. It has been found that grain separation across the span of the system (i.e., along the fan axis 204) can be improved, despite experiencing a reduction in the total volumetric flow rate through the fan rotor 202. The airflow has also been found to be more consistent over time as compared to systems lacking the inlet cover 226.

The inlet cover 226 may have any suitable shape. In the shown example, the inlet cover 226 has a curved portion 226a and a planar portion 226b. The curved portion 226a extends in the rotation direction from the fan cover leading edge 228 to an intermediate point where it joins the planar portion 226b. The planar portion 226b extends from the curved portion 226a to the fan cover trailing edge 230.

The curved portion 226a is shaped to have a concave side 226a′ facing the fan rotor 202. The curvature may be uniform across the entire length of the inlet cover 226 along the fan axis 204, but this is not strictly required. For example, in other embodiments, the curved portion 226a may have a radius of curvature that increases or decreases as a function of position along the rotation axis 204.

The planar portion 226b may extend continuously and tangentially from the curved portion 226a, such as shown, or it may extend at a distinct angle relative to the adjacent part of the curved portion 226a.

In some embodiments, the curved portion 226a or planar portion 226b may be omitted, modified or reconfigured. For example, the planar portion 226b may be omitted. As another example, the curved portion 226a may be located between the planar portion 226b and the inlet cover trailing edge 230 (i.e., the cover reversed). As another example, the curved portion 226a may be replaced by another planar portion that extends at an angle relative to the other planar portion 226b, such as to form a concavity between the two planar portions that faces the fan rotor 202. Other alternatives and variations will be apparent to persons of ordinary skill in the art in view of the present disclosure and with routine experimentation.

The inlet cover 226 also may include airflow-modifying structures. For example, the shown inlet cover 226 has a baffle 232 extending from the inlet cover trailing edge 230 towards the fan rotor 202. The baffle 232 is expected to help prevent reverse airflow, and may also direct incoming air in a more favorable direction to encourage conveyance to the fan rotor 202. In the shown case, the baffle 232 extends about 20 mm to about 30 mm and at an angle of about 45 degrees, but other dimensions are possible. Alternative baffle arrangements also may be used, such as repositioning the baffle 232 to the inlet cover leading edge 228, or adding a second baffle at the inlet cover leading edge 228. Baffles also may be provided at other locations.

The exemplary inlet cover 226 is positioned with the inlet cover leading edge 228 spaced from the rotation volume 216 at a first distance d₁ along the radial direction r, and the inlet cover trailing edge 230 from the rotation volume 216 at a second distance d2 along the radial direction r. In this example, the second distance d₂ is greater than the first distance d₁. However, it has been found that embodiments having a second distance d₂ that is equal to or less than the first distance d₁ can also provide benefits.

The inlet cover 226 may be positioned at any suitable location relative to the rotation direction, to thereby change the relative sizes of the first inlet passage 232a and the second inlet passage 232b.

It has been found that beneficial results are particularly provided by embodiments having certain dimensional properties. In one example, the fan rotor has a diameter D of about 400 millimeters (“mm”) to about 500 mm, and the inlet cover leading edge is spaced in the radial direction r from the rotation volume 216 by a distance d₁ of about 60 mm to about 90 mm, and more preferably about 75 mm.

The size of the inlet cover 226 can also affect performance. In the shown example, having the dimensions noted immediately above, the inlet cover 226 has a curved portion 226a with a radius of about 170 mm to about 210 mm. Such a curved portion 226a may extend along the rotation direction by, for example, a distance of at least about 180 mm (e.g., in the range of about 180 mm to about 220 mm). In addition, the planar portion 226b, if provided, may extend a distance of at least about 100 mm (e.g., in the range of about 100 mm to about 150 mm) from the intermediate location where it joins the curved portion 226a.

Referring now to FIGS. 3A-3C, embodiments of the cleaning fan system 200 may use inlet covers 226 having different surface constructions and shapes. The examples of FIGS. 3A-3C may be used in any combination (e.g., the shape of FIG. 3A with the surface construction of FIG. 3B or 3C).

In FIG. 3A, the inlet cover 226 comprises a solid surface that does not have any through openings, or it has through opening that do not create a measurable effect on grain separation performance (e.g., small open screw holes, narrow gaps between connected sheets, openings through rivet cores, etc.).

In the example of FIG. 3B, the inlet cover 226 comprises a perforated sheet of material (preferably metal), having holes 300 of sufficient size and number to affect the grain separation performance. For example, it has been found that a perforated sheet having about 30% to about 50% open area (e.g., 40% open/60% blocked) can provide a beneficial improvement on cross-distribution of the air along the fan axis 204. (As used herein, the open area percentage is the value of the total area of the openings divided by the sum of the total area of unperforated surface and the total area of the openings.) FIG. 3B also shows the inlet cover 226 being formed entirely of a curved shape (i.e., the planar portion is omitted). In addition, the inlet cover 226 has a second baffle 302 located at the inlet cover leading edge 328.

In FIG. 3C, the inlet cover 226 alternatively may comprise an expanded metal sheet, such as may be formed by forming linear slits in a metal sheet, then drawing opposite edges in a direction perpendicular to the slits to open the slits into diamond-shaped openings. The inlet cover 226 in this example is formed entirely as a planar shape (i.e., the curved portion is omitted).

Other alternatives and variations will be apparent to persons of ordinary skill in the art in view of the present disclosure. For example, the inlet cover 226 may comprise a polymer or plastic material, or it may comprise any combination of solid surfaces, perforated surfaces, expanded sheets, or the like.

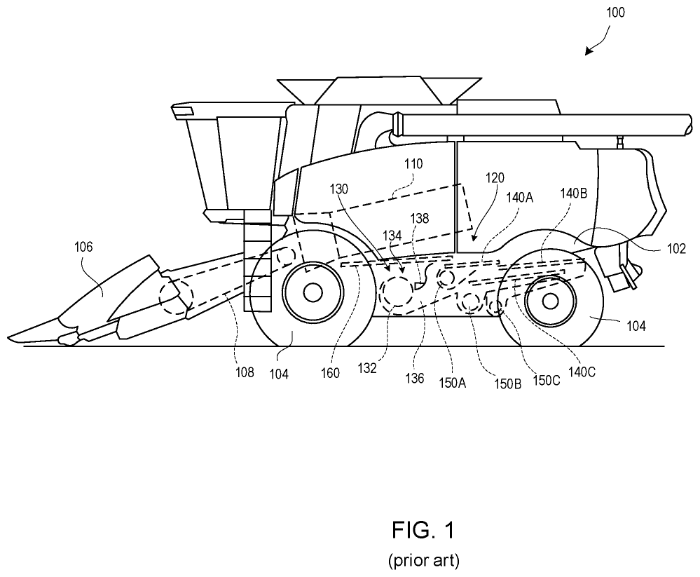

Improvements of the cleaning fan system 200 are expected to have particular utility in a combine harvester grain cleaning system, such as the combine harvester 100 described in relation to FIG. 1 or other systems. Such improvements are expected to arise from more stable and even distribution of the airflow along the rotation axis 204, which provides more even and predictable cleaning across the width of the cleaning system sieves 114.

The cleaning fan system 200, such as that described herein, may be provided as a standalone unit configured to be retrofitted to an existing combine harvester, for example as a replacement for the cleaning fan system 130 of the combine harvester 100, or other vehicle, or as a pre-installed assembly within a new combine harvester, such as a new combine harvester 100 having the cleaning fan system 200 instead of the conventional cleaning fan system 130, or other vehicle. Cleaning fan systems 200 may be provided as replacement units, or as kits to modify an existing cleaning fan system (e.g., a kit comprising an inlet cover 226 with parts and/or instructions for using the inlet cover 226 to modify an existing cleaning fan system). Other configurations are also possible.

The present disclosure describes a number of inventive features and/or combinations of features that may be used alone or in combination with each other or in combination with other technologies. The embodiments described herein are all exemplary, and are not intended to limit the scope of the claims. It will also be appreciated that the inventions described herein can be modified and adapted in various ways, and all such modifications and adaptations are intended to be included in the scope of this disclosure and the appended claims.

1. A harvester cleaning fan system comprising:
a cross flow fan rotor configured to rotate about a fan axis in a rotation direction and extending along the fan axis by a fan rotor length, the cross flow fan rotor having a plurality of vanes, each of the plurality of vanes extending in a radial direction away from the fan axis, from a respective proximal vane edge to a respective distal vane edge, the distal vane edges defining a cylindrical rotation volume having a rotation diameter;
a fan inlet extending in the rotation direction around a first portion of the cylindrical rotation volume from a fan inlet leading edge to a fan inlet trailing edge;
a fan outlet extending in the rotation direction from the fan inlet trailing edge to the fan inlet leading edge to enclose a second portion of the cylindrical rotation volume; and
an inlet cover positioned adjacent to the fan inlet and spaced in the radial direction outwardly from the rotation volume, the inlet cover extending in the rotation direction from an inlet cover leading edge to an inlet cover trailing edge, and extending along the fan axis along at least a majority of the fan rotor length, wherein:
the inlet cover leading edge and inlet cover trailing edge are located with respect to the rotation direction between the fan inlet leading edge and the fan inlet trailing edge,
the inlet cover leading edge is spaced in the rotation direction from the fan inlet leading edge to form a first inlet passage, and
the fan inlet trailing edge is spaced in the rotation direction from the inlet cover trailing edge to form a second inlet passage.

2. The harvester cleaning fan system of claim 1, wherein the inlet cover extends along the fan axis along an entirety of the fan rotor length.

3. The harvester cleaning fan system of claim 1, wherein the rotation diameter is about 400 mm to about 500 mm, and at least one of the inlet cover leading edge and the inlet cover trailing edge is spaced in the radial direction from the rotation volume by about 60 to about 90 mm.

4. The harvester cleaning fan system of claim 3, wherein the inlet cover leading edge is spaced in the radial direction from the rotation volume by about 75 mm.

5. The harvester cleaning fan system of claim 1, wherein the inlet cover comprises at least curved portion having a concave side facing the fan rotor.

6. The harvester cleaning fan system of claim 5, wherein the inlet cover leading edge is spaced in the radial direction from the rotation diameter by a first distance, the inlet cover trailing edge is spaced in the radial direction from the rotation volume by a second distance, and the second distance is greater than the first distance.

7. The harvester cleaning fan system of claim 5, wherein:
the rotation diameter is about 400 mm to about 500 mm;
at least one of the inlet cover leading edge and the inlet cover trailing edge is spaced in the radial direction from the rotation volume by about 60 to about 90 mm;
the curved portion has a radius of about 170 mm to about 210 mm; and
the curved portion extends along the radial direction by at least about 180 mm.

8. The harvester cleaning fan system of claim 5, wherein the inlet cover further comprises a baffle extending from the inlet cover trailing edge towards the fan rotor.

9. The harvester cleaning fan system of claim 5, wherein the curved portion extends from the inlet cover leading edge to an intermediate location between the inlet cover leading edge and the inlet cover trailing edge.

10. The harvester cleaning fan system of claim 9, wherein the inlet cover comprises a planar portion extending from the intermediate location to the inlet cover trailing edge.

11. The harvester cleaning fan system of claim 10, wherein:
the rotation diameter is about 400 mm to about 500 mm;
at least one of the inlet cover leading edge and the inlet cover trailing edge is spaced in the radial direction from the rotation volume by about 60 to about 90 mm;
the curved portion has a radius of about 170 mm to about 210 mm;
the curved portion extends along the radial direction by at least about 180 mm; and
the planar portion extends at least about 100 mm from the intermediate location to the inlet cover trailing edge.

12. The harvester cleaning fan system of claim 11, wherein the inlet cover further comprises a baffle extending from the inlet cover trailing edge towards the fan rotor.

13. The harvester cleaning fan system of claim 1, wherein the inlet cover comprises a solid surface.

14. The harvester cleaning fan system of claim 1, wherein the inlet cover comprises a plurality of openings.

15. The harvester cleaning fan system of claim 14, wherein the inlet cover comprises a perforated sheet having an open area of about 30% to about 50%.

16. The harvester cleaning fan system of claim 14, wherein the inlet cover comprises an expanded metal sheet.

17. An agricultural vehicle comprising:
a chassis configured for movement along a surface;
one or more sieves configured to separate grain from material other than grain; and
a fan system comprising:
a cross flow fan rotor configured to rotate about a fan axis in a rotation direction and extending along the fan axis by a fan rotor length, the cross flow fan rotor having a plurality of vanes, each of the plurality of vanes extending in a radial direction away from the fan axis, from a respective proximal vane edge to a respective distal vane edge, the distal vane edges defining a cylindrical rotation volume having a rotation diameter;
a fan inlet extending in the rotation direction around a first portion of the cylindrical rotation volume from a fan inlet leading edge to a fan inlet trailing edge;
a fan outlet extending in the rotation direction from the fan inlet trailing edge to the fan inlet leading edge to enclose a second portion of the cylindrical rotation volume; and
an inlet cover positioned adjacent to the fan inlet and spaced in the radial direction outwardly from the rotation volume, the inlet cover extending in the rotation direction from an inlet cover leading edge to an inlet cover trailing edge, and extending along the fan axis along at least a majority of the fan rotor length, wherein:
the inlet cover leading edge and inlet cover trailing edge are located with respect to the rotation direction between the fan inlet leading edge and the fan inlet trailing edge,
the inlet cover leading edge is spaced in the rotation direction from the fan inlet leading edge to form a first inlet passage, and
the fan inlet trailing edge is spaced in the rotation direction from the inlet cover trailing edge to form a second inlet passage.

18. The agricultural vehicle of claim 17, wherein the inlet cover extends along the fan axis along an entirety of the fan rotor length.

19. The agricultural vehicle of claim 17, wherein the inlet cover comprises at least curved portion having a concave side facing the fan rotor.

20. The agricultural vehicle of claim 19, wherein the curved portion extends from the inlet cover leading edge to an intermediate location between the inlet cover leading edge and the inlet cover trailing edge, and the inlet cover comprises a planar portion extending from the intermediate location to the inlet cover trailing edge.

21. The agricultural vehicle of claim 20, wherein:
the rotation diameter is about 400 mm to about 500 mm;
at least the inlet cover leading edge is spaced in the radial direction from the rotation volume by about 60 to about 90 mm;
the curved portion has a radius of about 170 mm to about 210 mm;
the curved portion extends along the radial direction by at least about 180 mm; and
the planar portion extends at least about 100 mm from the intermediate location to the inlet cover trailing edge.

22. The agricultural vehicle of claim 20, wherein the inlet cover further comprises a baffle extending from the inlet cover trailing edge towards the fan rotor.

23. The agricultural vehicle of claim 17, wherein the inlet cover comprises a solid surface, a perforated sheet having an open area of about 30% to about 50%, or an expanded metal sheet.
